(19) United States
(12) Patent Application Publication
(10) Pub. No.: US 2020/0086904 A1
(43) Pub. Date: Mar. 19, 2020

(54) System and Method for Moving Multiple Drywalls in Tight Spaces

(71) Applicant: Oscar A. Reynoso, Houston, TX (US)

(72) Inventor: Oscar A. Reynoso, Houston, TX (US)

(21) Appl. No.: 16/132,465

(22) Filed: Sep. 17, 2018

(51) Int. Cl. B62B 3/10; B62B 3/02

(52) U.S. Cl. CPC B62B 3/108; B62B 2203/60; B62B 2206/04; B62B 3/02

(57) ABSTRACT

This disclosure teaches a system and method for moving multiple drywalls in tight spaces. A dolly device can comprise a pair of vertical brackets, and a platform. Each of the vertical brackets can comprise a top joint and a bottom joint. The bottom joint can be slideable within the top joint. The platform can mount the vertical brackets. The platform can comprise a front surface and a back surface. The front surface can be slideable within the back surface.

### BACKGROUND

This disclosure relates to a system and method for moving multiple drywalls in tight spaces.

Drywall has been used for decades for creating interior walls and ceilings. It is a faster, easier, and inexpensive way in doing renovation, repairs, and building new construction. Drywall varies in sizes and thickness though a 4×8 drywall are most commonly used as it can be easiest to handle. However, moving and carrying drywall is not usually an easy task especially if it involves transferring several drywall. The most common method of transferring drywall is having two people carry and move drywall from a place to another. But, it can be time consuming and tiring. Moreover, this method can only be effective through a buddy-system hence would always be dependent with another person. As such a carrier device was developed to cater this problem. This carrier device can be used to attach, or support a drywall on one side, while the opposite side can be supported by a person carrying it. In such method, it will be possible for a single person to handle and move drywall. However, this method can only work with transferring one drywall at a time. Therefore other device that uses wheels is devised to address this problem. Though wheeled-carrier served its purpose for transferring multiple drywalls at a time, it cannot be used in transferring multiple drywall in tight spaces such as elevators, door, or areas with low ceiling. As such it would be useful to have an improved system and method for moving multiple drywalls in tight spaces.

### SUMMARY

This disclosure teaches a system and method for moving multiple drywalls in tight spaces. A dolly device can comprise a pair of vertical brackets, and a platform. Each of the vertical brackets can comprise a top joint and a bottom joint. The bottom joint can be slideable within the top joint. The platform can mount the vertical brackets. The platform can comprise a front surface and a back surface. The front surface can be slideable within the back surface.

This disclosure also teaches a method for moving one or more drywalls to a tight space. The method can comprise the step of mounting the drywalls onto a dolly. The dolly can comprise a pair of vertical brackets, and a platform. Each of the vertical brackets can comprise a top joint and a bottom joint. The bottom joint can be slideable within the top joint. The platform can mount the vertical brackets. The platform can comprise a front surface and a back surface. The front surface can be slideable within the back surface.

### BRIEF DESCRIPTION OF THE DRAWINGS

FIG. 1 illustrates a dolly carrying one or more drywalls.

FIG. 2 illustrates an exploded view of a dolly.

FIG. 3 illustrates a frame comprising a pair of vertical brackets, a plurality of horizontal frames, and a pair of pins.

FIG. 4A illustrates an embodiment of a bottom joint comprising a threaded portion.

FIG. 4B illustrates an embodiment of a joint portion comprising a plurality of holes.

FIG. 5A illustrates a platform comprising a pair of ledges, and a depressed portion.

FIG. 5B illustrates a front surface comprising a lip.

FIG. 5C illustrates a side view of a platform.

FIG. 6A illustrates a front surface in expanded form.

FIG. 6B illustrates a front surface in contracted form.

### DETAILED DESCRIPTION

Described herein is a system and method for moving multiple drywalls in tight spaces. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

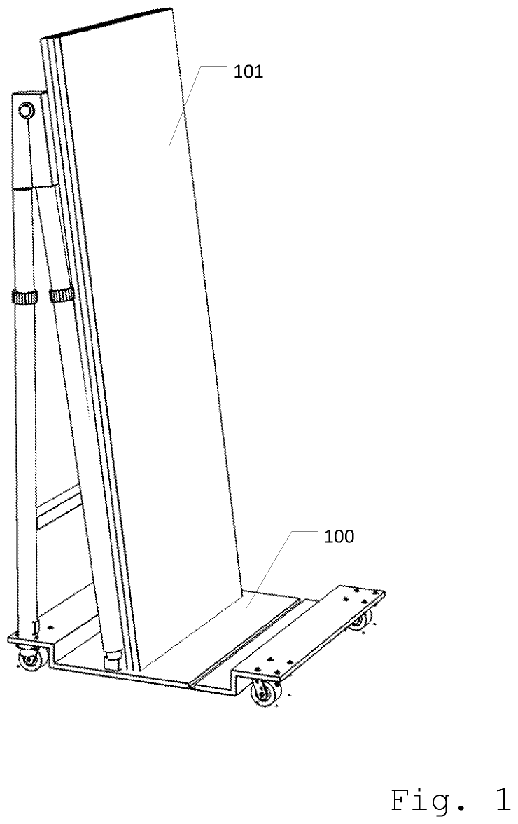

FIG. 1 illustrates a dolly 100 carrying one or more drywalls 101. Dolly 100 can be a mobile platform used for moving drywalls 101 in a tight area. For purposes of this disclosure, drywalls 101 can be any type of panel that is used for interior wall or interior ceiling material. Drywalls 101 can be any sheet material such as a sheet rock, paneling, or plywood.

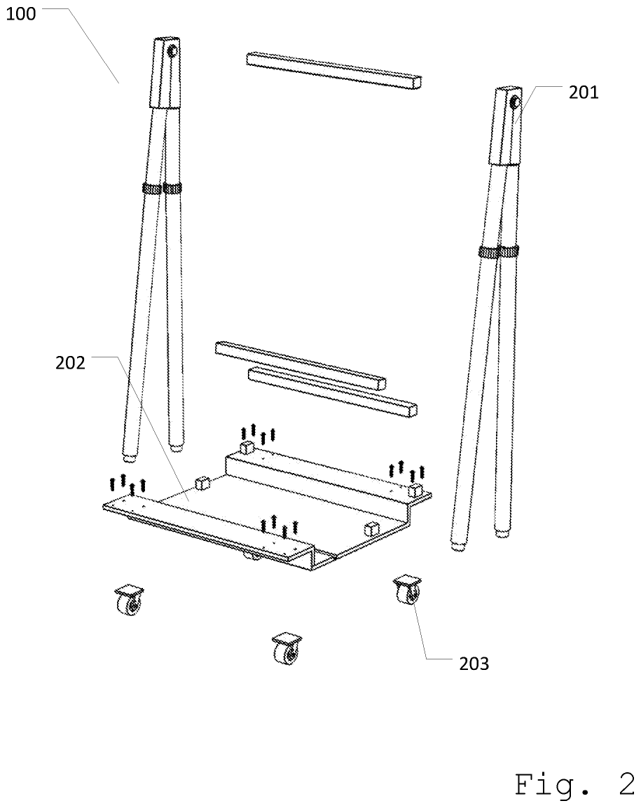

FIG. 2 illustrates an exploded view of dolly 100. Dolly 100 can comprise a frame 201, a platform 202, and, a plurality of rollers 203. Frame 201 can be made from durable material such as metal or steel. Frame 201 can be a rigid structure that can support the weight of drywalls 101. Moreover, frame 201 can allow drywalls 101 be moved at a slanting position. Therefore, allowing drywalls 101 to be moved and fit on a closed space or tight area such as a door, or an elevator. Platform 202 can be made of durable material such as metal, wood, or steel capable of bearing the weight of drywalls 101. Platform 202 can be a rectangular horizontal surface wherein drywalls 101 are mounted. As such, platform 202 can be capable of bearing the mass of drywalls 101. Rollers 203 can be any type of caster wheels attached at the bottom surface of platform 202. Rollers 203 can allow dolly 100 to be easily maneuvered to a desired location. Rollers 203 can be heavy duty casters capable of supporting the weight of dolly 100 and drywalls 101. Rollers 203 can be a swivel caster to allow dolly 100 be easily maneuvered. For purposes of this disclosure, swivel caster allows rotation at 360 degrees. Thus, enabling rollers 203 to move in any direction. In one embodiment, rollers 203 can include a brake or lock features. This embodiment can ensure that dolly 100 does not accidentally slip or move.

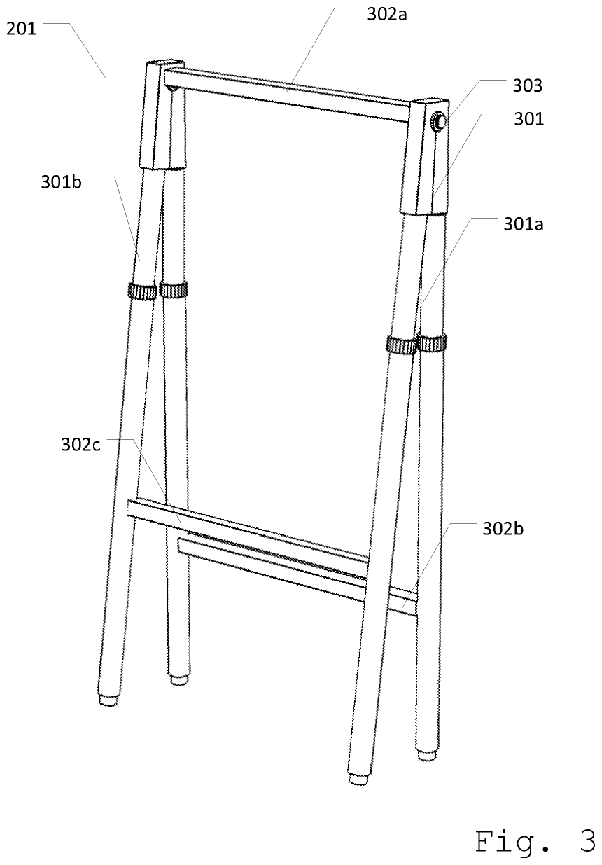

FIG. 3 illustrates frame 201 comprising a pair of vertical brackets 301, a plurality of horizontal frames 302, and a pair of pins 303. Vertical brackets 301 can be a material attached together on one end comprising a first vertical bracket 301a and a second vertical bracket 301b to form an inverted V-shape. As such, first vertical bracket 301a can be fixed in a straight vertical position, while second vertical bracket 301b can be attached at the top end of first vertical bracket 301a in an inclined position. Thus, second vertical bracket 301b can be longer than first vertical bracket 301a. Further, horizontal frames 302 can be a shaft that connects two vertical frames 301 together. Moreover, horizontal frames 302 can be attached in between vertical frames 301 to provide rigid support for frame 101. As such, both ends of a first horizontal frame 302a can be used to attach the top portion of vertical brackets 301 together. While, both ends of second horizontal frame 302b connect the middle portion of first vertical brackets 301a. Lastly, both ends of third horizontal frame 301c can connect the middle portion of second vertical brackets 301b. Pins 303 can be a type of fastener that can allow vertical brackets 301 to move freely. As such, pins 303 can allow second vertical brackets 301b be slideable on top of platform 202. Since pins 303 can allow second vertical bracket 301b to move freely, second vertical bracket 301b can be adjusted towards or away from first vertical brackets 301a forming an angle. In one embodiment, each vertical bracket 301 can comprise a joint 304. Joint 304 can be a portion on vertical brackets 301 that allows adjustment of height and angle of vertical brackets 301. Moreover, joint 304 can comprise a top joint 304a and a bottom joint 304b that connects at the middle of vertical brackets 301. As such, a portion of bottom joint 304b can be slideable within a portion of top joint 304a. In such embodiment, one end of bottom joints 304b can be permanently attached at the top surface of platform 202 through soldering, welding, or cementing.

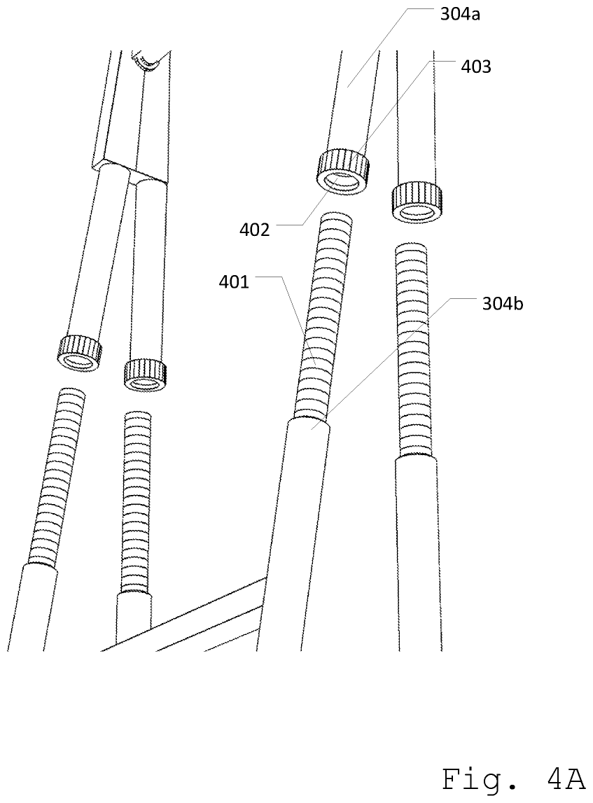

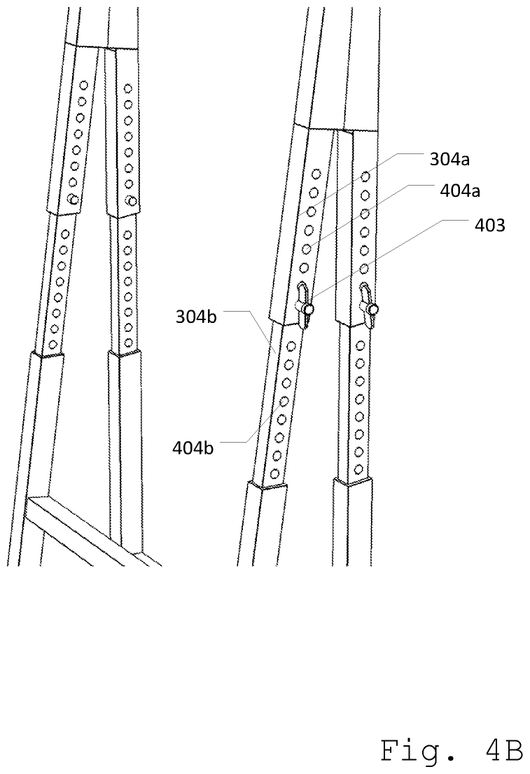

FIG. 4A illustrates an embodiment of bottom joint 304b comprising a threaded portion 401. In such embodiment, threaded portion 401 of bottom joint 304b can be slideable within said top joint 304a. Therefore, top joint 304a can be adjusted within threaded portion 401. This setup can allow top joint 304a to be extended upward. As such top joint 304a can comprise a chamber 402 and a fastener 403. Chamber 402 can be a hollow opening within top joint 304a. Thus, chamber 402 can be configured mateable with bottom joint 304b. In this embodiment, fastener 403 can be configured as a nut, such that when the desired height of vertical brackets 301 is achieved fastener 403 can be used to tighten top joint 304a within threaded portion 401 of bottom joint 304b. As such, fastener 403 can affix the position of top joint 304a on bottom joint 304b.

FIG. 4B illustrates an embodiment of joint portion 304 comprising a plurality of holes 404. In this embodiment, the top portion of bottom joint 304b can comprise a plurality of first holes 404a while the bottom portion of top joint 304a can comprise a plurality of second holes 404b. As such, first holes 404a can have the same diameter with second holes 404. In this embodiment, first holes 404a can be aligned with second holes 404. Once holes 404 are aligned fasteners 403 can be inserted within the holes to fix the position of vertical brackets 301. Thus in this embodiment, fasteners 403 can be any fastening device such as screws, nuts, and bolts.

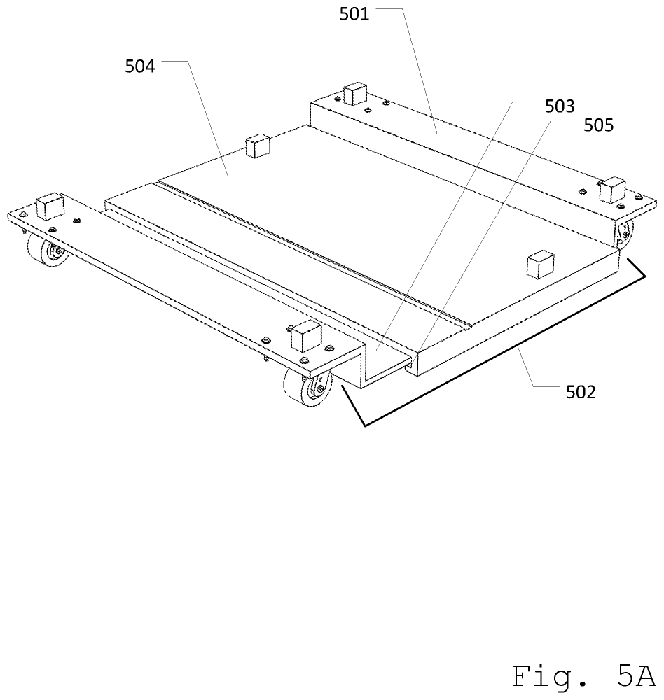

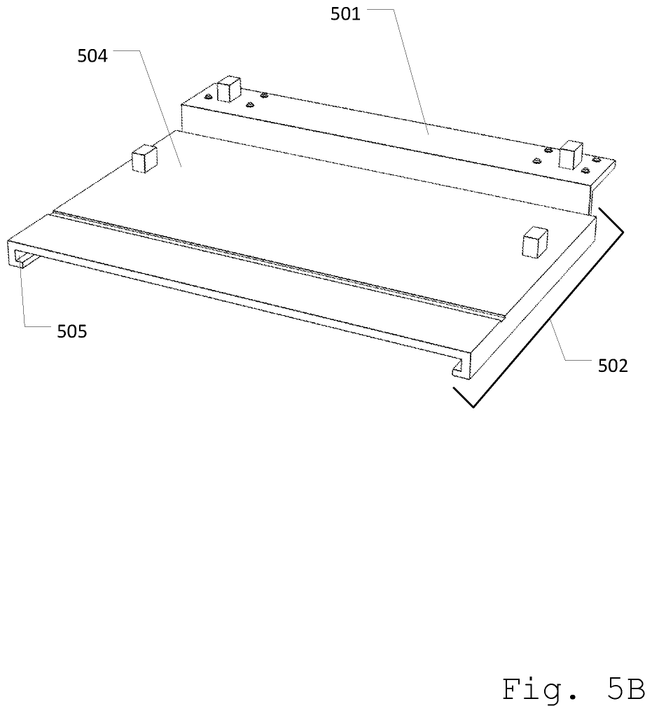

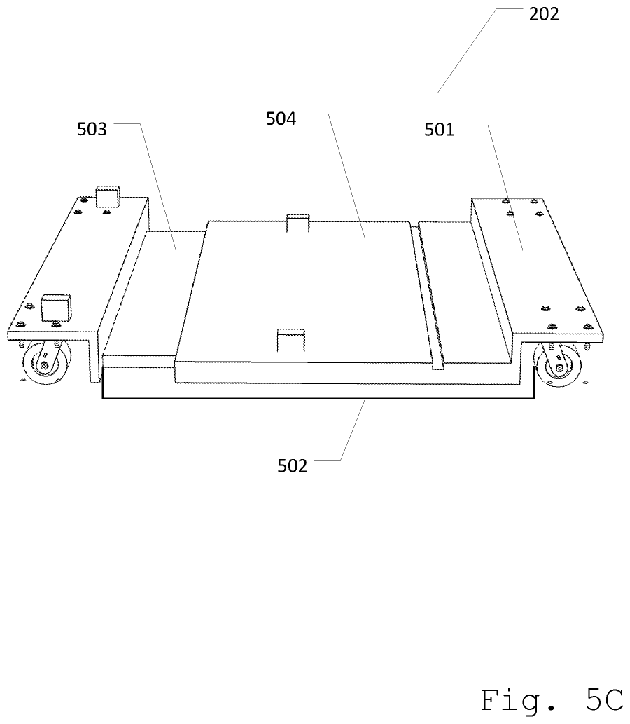

FIG. 5A illustrates platform 202 comprising a pair of ledges 501, and a depressed portion 502. Ledge 501 can be a protruding surface on platform 202 that forms an L-shape. Ledge 501 can be placed at the opposite outer edge of platform 202 therefore forming depressed portion 502. Depressed portion 502 can be the surface wherein drywalls 101 can be mounted. Such structure can allow tall loads such as drywalls 101 be closer to the ground. Further, ledge 501 can prevent drywalls 101 from slipping out of the front side of platform 202. In one embodiment, platform 202 can comprise a front surface 503 and a back surface 504. Front surface 503 can be the adjustable portion of platform 202. As such, front surface 503 can slide out and slide in from back surface 504. In this embodiment, first vertical brackets 301a can be attached at the top portion of back surface 504 while second vertical brackets 301b can be attached at the top portion of front surface 503. Therefore in this structure adjusting joints 304 on second vertical brackets 301b can allow front surface 503 to either expand to front or contract back towards back surface 504.

FIG. 5B illustrates a front surface 503 comprising a lip 505. Lip 505 forms the extended portions of back surface 504. Furthermore, lip 505 can be placed at the bottom surface of back surface 504. In one embodiment as shown in FIG. 5B, back surface 504 can form a C-shape. In another embodiment, lip 505 can form an enclosure that completely wraps front surface 503. Thus, lip 505 provides an enclosure that wraps around the outer portion of front surface 503 that allows front surface 503 to slide in and out from back surface 504. Additionally, in this embodiment platform 202 can utilize fasteners 403 that can affix front surface 503 in a desired position.

FIG. 5C illustrates a side view of platform 202. In a contracted form ledge 501 can prevent front surface 503 from slipping out of back surface 504. Furthermore, fasteners 505 can provide an additional hold in securing front surface 503 in a desired position.

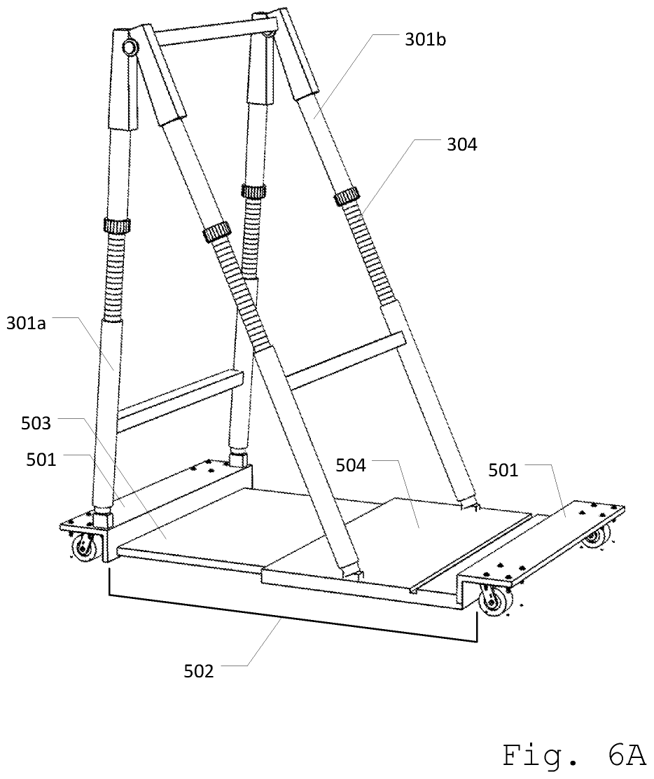

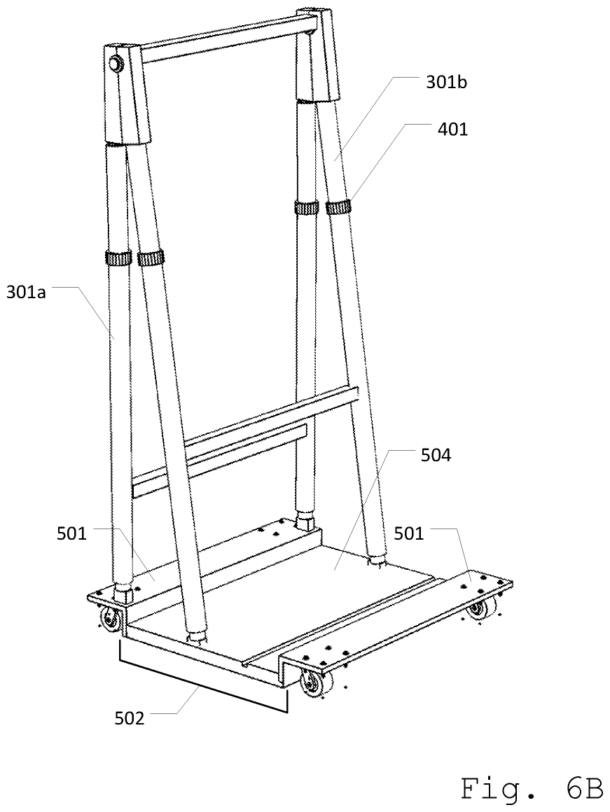

FIG. 6A illustrates front surface 503 in expanded form. In this embodiment, vertical brackets 301 can form a maximum angle. As such second vertical brackets 301b can also be in expanded form. In such setup, drywalls 101 can be maneuvered in areas with low clearance.

FIG. 6B illustrates front surface 503 in contracted form. In this embodiment, vertical brackets 301 can form a minimum angle. Similarly second vertical brackets 301b can be in contracted form. Furthermore, fasteners 505 can be used to secure front surface 503 in its contracted position. Since drywalls 101 can be slantly mounted onto dolly 100 this will allow multiple drywalls 101 to fit on tight space. Thus, placing the bottom portion of drywalls 101 at the top surface of depressed portion 502 and resting the side portion of drywalls 101 with second vertical brackets 301b. In one embodiment, a strap can be used to fasten drywalls with dolly 100. This can ensure that drywalls 101 are kept in place or does not accidentally slip off from platform 202 during transportation of drywalls 101. As such, drywalls 101 can be maneuvered in areas with tight spaces such as doors or elevators.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A dolly device comprising
a pair of vertical brackets, each of said vertical brackets comprising a top joint and a bottom joint, wherein said bottom joint slideable within said top joint; and
a platform mounts said vertical brackets, further wherein said platform comprises a front surface and a back surface, wherein said front surface slideable within said back surface.

2. The system of claim 1 wherein said bottom joint further comprises a threaded portion, wherein said top joint adjustable within said threaded portion.

3. The system of claim 2 wherein said top joint comprises a chamber, said chamber insertable by said bottom joint.

4. The system of claim 3 further comprising a fastener, wherein said fastener can be attached at the bottom of said top joint such that said fastener affixes position of said top joint on said bottom joint.

5. The system of claim 1 wherein said top joint comprises a plurality of first holes that is compatible with a plurality of second holes on said bottom joint.

6. The system of claim 5 further comprising a fastener insertable through said first holes and said second holes.

7. The system of claim 1 wherein said platform further comprising a lip, said lip placed at the bottom surface of said back surface and wraps around the outer portion of said front surface.

8. A method for moving one or more drywalls to a tight space comprising
mounting said drywalls onto a dolly, said dolly comprising
a pair of vertical brackets, each of said vertical brackets comprising a top joint and a bottom joint, wherein said bottom joint slideable within said top joint; and
a platform mounts said vertical brackets, further wherein said platform comprises a front surface and a back surface, wherein said front surface slideable within said back surface.

9. The method of claim 8 wherein said bottom joint comprises a threaded portion, said top joint adjustable within said threaded portion.

10. The method of claim 9 further comprising the step of fixing said top joint within said threaded portion through a fastener.

11. The method of claim 8 further comprising the step of extending said front surface from said back surface of said platform.
